(19) United States
(12) Patent Application Publication
(10) Pub. No.: US 2010/0238278 A1
(43) Pub. Date: Sep. 23, 2010

(54) Videoendoscopy system

(75) Inventor: Jean Rovegno, La Ciotat (FR)

Correspondence Address: SEED INTELLECTUAL PROPERTY LAW GROUP PLLC, 701 FIFTH AVE, SUITE 5400, SEATTLE, WA, 98104, US

(73) Assignee: TOKENDO, La Ciotat (FR)

(21) Appl. No.: 12/694,218

(22) Filed: Jan. 26, 2010

(30) Foreign Application Priority Data
Jan. 27, 2009 (FR) 09 00341
Feb. 12, 2009 (FR) 09 00621

(51) Int. Cl. H04N 7/18

(52) U.S. Cl. 348/75; 348/E07.085

(57) ABSTRACT

The invention relates to a videoendoscopic system comprising a videoendoscopic equipment unit comprising an image sensor and a video processing circuit linked to the image sensor, and configured to supply synchronization signals and direct voltages, necessary to the operation of the video processing circuit and the image sensor, supply a standardized analog video signal directly usable by a video monitor from electrical signals supplied by the image sensor, on a low-impedance video link of a proximal multicore cable, receive a direct supply voltage through a supply link of the proximal multicore cable, and receive a control signal through a control link of the proximal multicore cable.

The present invention relates to videoendoscopic systems, and more particularly to systems comprising a flexible videoendoscopic probe, and systems comprising an endoscopic camera or a low-length rigid videoendoscopic probe, such as those used in laparoscopy, thoracoscopy and bronchoscopy. The present invention also relates to the control of an endoscopic camera or videoendoscopic probe and the use of video signals supplied by these equipment units. The present invention relates to medical systems as well as systems used in endoscopic industrial control.

The terms “endoscope” or “fiberscope” generally refer to a rigid or flexible endoscopic probe comprising a distal end intended to be introduced into a dark cavity, so as to observe inside the cavity through an eyepiece. To that end, an endoscope comprises an optical device, and a lighting device. The optical device comprises a distal objective, an optical transmission device for optically transmitting the image supplied by the distal objective, and an eyepiece allowing the user to observe the image supplied by the transmitting device. The objective is housed in the distal end of an inspection tube. The optical transmitting device, also housed in the inspection tube, links the objective to the eyepiece. The optical transmitting device may be rigid and comprise a series of lenses, or flexible and comprise a beam of ordered optical fibers.

The lighting device comprises a continuous beam of optical fibers successively passing from the distal end of the probe, through the inspection tube, and through the sheath of an umbilical cable. The proximal end of the beam of fibers comprises a proximal tip to be connected to a light generator. The distal end of the beam of fibers is arranged in the distal end of the probe so as to be able to light the field of the objective.

The term “videoendoscope” generally refers to an endoscopy system allowing the image of a target located in a dark cavity to be observed on a video screen. A videoendoscopic system comprises a camera associated to an endoscope, or a videoendoscopic probe.

A videoendoscope implementing an endoscopic camera conventionally comprises a traditional endoscope or fiberscope associated to a white light generator through a fibered lighting cable, a camera, an objective, an umbilical cable, a video processor, a control panel, and a screen for visualizing video images.

The camera comprises an image sensor housed in a distal part of the camera. The image sensor comprises a photosensitive surface onto which an objective to which it is associated forms an image. The objective may be removably fixed onto the distal end of the camera. The distal end of the objective is equipped with a quick locking device allowing a proximal auxiliary lens of an endoscope or a fiberscope to be connected thereto. The video processor, preferably housed in the camera, is configured to transform into a standardized video signal (complying with a video standard) the electrical signal supplied by the image sensor to which it is linked through a multicore electrical cable housed in the umbilical cable. The video processor is synchronized with the image sensor, the synchronization being originally set according to the length and electrical features of the multicore cable. The flexible umbilical cable has a distal end attached to the camera and a proximal end equipped with a multipin electrical connector allowing the camera to be connected to an operating equipment unit. The control panel is generally embedded on an operating equipment unit associated to the camera. The control panel allows the user to set operation parameters of the video processor. The visualization screen, generally associated to the operating equipment unit, allows the standardized video signal supplied by the video processor to be viewed.

Generally, a color endoscopic camera comprises one or three image sensors. A camera with three image sensors, for example of the type “three-CCD”, comprises a three-path chromatic splitter, each path being coupled to a monochromatic image sensor. A camera with a single image sensor, for example of the type “single CCD”, comprises a single tricolor image sensor. Endoscopic cameras are commonly equipped with an image sensor of the type “interline transfer three-CCD”.

Endoscopic cameras are mainly used in the medical field. They must be associated to an operating equipment unit supplying several types of video signals and comprising a keyboard allowing the image features to be modified. The recurrent issue linked to this type of videoendoscope relates to the electrical compatibility of the camera with the operating equipment unit.

A videoendoscopic probe conventionally comprises an inspection tube, a control handle attached to the proximal end of the inspection tube, a lighting device, a video processor, a flexible umbilical cable, a control panel and a visualization screen. The inspection tube, of flexible or rigid type, has a distal end attached to a distal tip. The distal tip houses an optoelectronic device of small dimensions comprising in particular the image sensor associated to an objective forming an image onto the photosensitive surface of the image sensor. The image sensor is for example of the type “interline transfer three-CCD sensor”. The control handle is attached to the proximal end of the inspection tube and the distal end of the umbilical cable. The proximal end of the umbilical cable comprises a light connector and a multipin electrical connector allowing the probe to be connected to a light generator and to an operating equipment unit. The lighting device generally comprises a beam of lighting fibers successively housed in the umbilical tube, the control handle, and the inspection tube. The distal end of the beam of lighting fibers is housed in the distal tip to light the field of the objective. The proximal end of the beam of lighting fibers is integrated into a multiple connector at the proximal end of the umbilical cable to be able to be connected to a light generator. The video processor, integrated for example into the control handle, is configured to transform into a standardized video signal the electrical signal supplied by the distal image sensor to which it is linked through a multicore electrical cable housed in the inspection tube. The video processor is synchronized with the image sensor by a setting originally performed according to the length and electrical features of the multicore electrical cable housed in the inspection tube linking it to the image sensor. The flexible umbilical cable has a distal end attached to the control handle and a proximal end equipped with a multipin connector allowing the probe to be connected to an operating equipment unit. The control key panel allows the user to set the operation parameters of the video processor, and the visualization screen allows the standardized video signal supplied by the video processor to be viewed.

Some videoendoscopic probes may also comprise a distal jointed tip deflection, allowing the direction of the distal tip of the probe to be modified. The tip deflection is associated to mechanical or electromechanical control means which are generally integrated into the control handle. Some videoendoscopic probes may also be coupled to interchangeable optical heads which may be locked on the distal tip of the probe, and allowing all of the following parameters or some of them to be modified: the field covered by the probe, the focusing distance, the depth of field, and the viewing direction.

The operating equipment unit susceptible of being operably associated to the proximal end of the umbilical cable of a videoendoscopic probe generally comprises a power supply circuit connected to a battery or a source of alternating or direct current, and a light generator conventionally organized around a halogen or xenon lamp. The operating equipment unit may also comprise a digital device for freezing, saving and processing images, and/or a metrology device allowing the user to measure in situ, from the video image previously frozen of a target being inspected, the real dimensions of some elements of the target. The implementation of such a metrology device generally requires a specific optical component integrated into a removable distal head and a specific pointing and calculation program managed by the image processing digital device.

Historically, the first videoendoscopy systems were organized around an operating equipment unit integrating the video processor and the control panel. The umbilical cable of the endoscopic camera or the videoendoscopic probe comprised a multipin electrical connector to be connected to the equipment unit which was specific to the model of camera or probe. The main issue raised by this type of system related to the interchangeability or compatibility of cameras or probes with the operating equipment unit. This compatibility issue is mainly linked to the synchronization of the image sensor with the video processor. In fact, the joint operation of an image sensor of the type color CCD associated to a video processor essentially results in a correct management of the phase shifts of various fast clock signals generated by clock circuits of the video processor. The clock signals first comprise fast or “pixel” clock signals which are transmitted to the image sensor to synchronize the reading of the electrical voltages of the unitary cells (or “pixels”) of the photosensitive layer of the sensor. The fast clock signals also make it possible to extract from the voltages read significant information which constitute, after integration, an image signal which is transmitted to the video processor. These clock signals also comprise sampling clock signals synchronizing a sampling process performed by the video processor, of the image signal supplied by the image sensor.

The correct operation of the video processor imperatively requires that the sampling clock is perfectly in phase with the image signal supplied by the image sensor. Now, the offset of the image sensor into the distal end of the videoendoscopic probe inevitably introduces, due to the length of the electrical links between the sensor and the video processor, an unacceptable phase shift between the sampling clock generated by the video processor and the image signal. This phase shift results from the accumulated total of the transmission time to the image sensor of the synchronization signals generated by the video processor, and the transmission time to the video processor of the image signal generated by the image sensor. Generally, to remedy such a dysfunction, the phase shift is compensated by delaying the sampling clock, or the pixel synchronization clock. The implementation of one or the other of these delays depends on the integration location of the video processor which may be external or integrated into the videoendoscopic probe.

Thus, the integration of the video processor into an operating equipment unit causes adaptation issues due to the necessity of compensating synchronization delays induced by the electrical cable linking the video processor to the image sensor. If the operating equipment unit is always associated to a same model of camera or probe, there is an interchangeability issue requiring that the umbilical cable has always exactly the same length. If the operating equipment unit is intended to be associated to a range of videoendoscopic probes having various lengths, there is a compatibility issue requiring providing in the connection housing or in the control handle of the probe a specific adjustable delay device, acting on the fast clock signals of the video processor which are transmitted to the image sensor. Solutions of this type have been described in the patents U.S. Pat. No. 4,539,568, FR 2 737 650 and FR 2 761 561.

The implementation of an external video processor has another technical drawback relating to the risks of disturbance on the image signal generated by the image sensor and transmitted to the video processor. In fact, transmitting the image signal reveals to be sensitive due to its low intrinsic signal to noise ratio, due in particular to the presence of residues of the synchronization signal, its wide bandwidth and low power requiring a high impedance link (higher than 100 Ohm). The link between the image sensor and the video processor therefore does not contribute to offer a good immunity against disturbances to the image signal generated by the image sensor. In addition, the umbilical cable is very complex.

Given the drawbacks previously mentioned, it is desired to arrange the video processor the nearest to the distal image sensor. Thus, in the case of an endoscopic camera, if the video processor is directly integrated into the head of the camera, the critical link between the image sensor and the video processor is suppressed.

In the case of a videoendoscopic probe, if the video processor is integrated into the control handle, the length of the critical link between the image sensor and the video processor is reduced to the length of the inspection tube. The synchronization of the video processor with the distal image sensor then only depends on the length of the inspection tube.

In addition, if the video processor is placed the nearest to the image sensor, the useful video signal supplied by the video processor and transmitted by the umbilical cable of the endoscopic camera or the videoendoscopic probe, is then little sensitive to the risks of disturbance due to its relatively high signal to noise ratio, as well as its power which is adapted to a low impedance link (lower than 100 Ohm).

Unfortunately, the dimensions of a conventional video processor usually reveal to be incompatible with the available volume, in a head of endoscopic camera, as well as in the control handle of a videoendoscopic probe. The video processor must indeed integrate various main functions of signal processing, and various auxiliary functions (control logic, amplification, filtering, power supply, etc.) required to its operation and use. The result is that only the industrial videoendoscopic probes having a control handle with a visualization screen and a control panel, have a sufficient volume to integrate the video processor therein. Such a videoendoscopic probe is described in particular in the patents FR 2 785 132 (U.S. Pat. No. 6,315,712) and FR 2 850 229 (U.S. Pat. No. 7,074,182). In addition, the patent U.S. Pat. No. 5,702,345 describes a videoendoscopic probe which video processor is integrated into a connection housing attached to the proximal end of the umbilical cable. In all the industrial videoendoscopic probes mentioned above, the operating equipment unit to which the probe is associated then mainly comprises a light generator and a power supply circuit.

On the contrary, in medical videoendoscopes, whatever endoscopic camera or videoendoscopic probe they comprise, the control handle has small dimensions and only houses a mechanical control of the tip deflection. The visualization screen and the control panel are not integrated into the control handle, but systematically offset into an operating equipment unit.

The increasing miniaturization of electronic components has led to a progressive evolution of the electronic architecture of videoendoscopic probes, which has allowed an efficient solution to the recurrent compatibility issue mentioned above to be found. It is however to be noted that this evolution took different forms depending on the medical or industrial goal of the equipment concerned.

In the field of industrial control, this evolution has consisted in increasing the volume of the control handles of videoendoscopic probes, so as to house more and more electronic functions therein. Currently, videoendoscopic probes become totally autonomous since the control handle houses all the functions of a videoendoscope, i.e.: a powered control of the tip deflection, a video processor, a control keyboard, a diode light generator, a visualization screen, and even an electrical supply battery.

In the medical field, the volumes of camera heads (or of handles of videoendoscopic probes) are limited for ergonomic reasons. For this reason, it has been sought to distribute the various functions of the videoendoscope in the camera heads (or handles of videoendoscopic probes), in the connectors of umbilical cables and the operating equipment units to which umbilical cables are connected.

A first evolution has consisted in housing the synchronization circuit into a connector at the proximal end of the umbilical cable. This architecture facilitates the interchangeability on a same probe operating equipment unit having an identical technology, but with umbilical cables of different lengths. However, this architecture does not resolve at all the transmission issue in the umbilical cable of the image signal supplied by the image sensor.

A second evolution has consisted in housing into the camera head circuits of synchronization, preprocessing of the image signal supplied by the image sensor and an analog-to-digital converter to convert the image signal. In this architecture, the digital signals supplied by the analog-to-digital converter are transmitted through the umbilical cable to an operating equipment unit housing a video processing circuit. This architecture reveals to be delicate to implement due in particular to the complexity of the umbilical cable which transmits the digital video signals in parallel, and the necessity to synchronize from a same clock circuit the camera head and the video processing circuit linked by the umbilical cable.

The patent U.S. Pat. No. 6,947,070 (US 2002/0171733) describes an operating equipment unit which may be connected to a videoendoscopic equipment unit (endoscopic camera or videoendoscopic probe) supplying a Y/C video signal and/or a Y/R-Y/B-Y video signal. The operating equipment unit is arranged to supply composite Y/C video signals, and R/G/B/Synchro signals. The videoendoscopic equipment unit houses a clock signal generator, video processing circuits supplying R/G/B signals, and one or two encoders supplying Y/C video signals and Y/R-Y/B-Y/Synchro signals. This architecture requires providing an umbilical cable of a certain complexity to be able to transmit the synchronization signal of the image sensor, the Y/C components and the Y/R-Y/B-Y components.

The patent FR 2 857 200 (US 2005/018042) describes a head of endoscopic camera or a control handle of videoendoscopic probe integrating circuits of synchronization and process of the image signal. The head or handle is linked through an umbilical cable to an operating equipment unit housing a power supply circuit, a video processing processor, and a control microcontroller. In a simplified version, it is considered to integrate the functions of power supply, video processing and control into a connector at the proximal end of the umbilical cable. This architecture also complicates the structure of the umbilical cable. In addition, the integration of video processing circuits into the operating equipment unit or a connector, render the connection interface of the camera head or the control handle specific to the image sensor used.

Thus, it may be desired to simplify the architecture of such videoendoscopy systems, and in particular the architecture of the operating equipment unit, without reducing the abilities and functions thereof.

It may also be desired to make an operating equipment unit which is compatible with a great variety of endoscopic cameras and videoendoscopic probes, equipped with cameras with three image sensors or a single one, with image sensors which may be of various natures (CMOS/CCD) and having different resolutions and interfaces. In this context, it may also be desired to make an operating equipment unit having a using interface identical whatever the type of videoendoscopic equipment unit connected to the operating equipment unit. It may also be desired that the operating equipment unit only comprises a single connection base to be connected to an endoscopic camera or a videoendoscopic probe. It may also be desired to reduce the number of unitary conductors provided in the umbilical cable. It may also be desired that the umbilical cable does not transmit electrical signals sensitive to disturbances, and that it may be removable and interchangeable without causing disturbance or compatibility issues with videoendoscopic equipment units (endoscopic probes or cameras), due to its length and the presence of connectors.

Embodiments concern a videoendoscopic equipment unit comprising an image sensor and a video processing circuit linked to the image sensor and configured to supply a video signal from electrical signals provided by the image sensor, the video processing circuit being configured to: generate and transmit synchronization signals and direct voltages, necessary for the operation of the video processing circuit and the image sensor, supply a standardized analog video signal directly usable by a video monitor on a low-impedance video link of a proximal multicore cable, receive a direct supply voltage through a supply link of the proximal multicore cable, and receive control signals through a control link of the proximal multicore cable.

According to an embodiment, the video processing circuit comprises an identification circuit configured to transmit through the control link an identification information of a type of the videoendoscopic equipment unit.

According to an embodiment, the video processing circuit comprises a remote control circuit linked to a control link of the proximal multicore cable for remotely controlling through the control link an operating equipment unit connected to the proximal multicore cable.

According to an embodiment, the videoendoscopic equipment unit has a type belonging to a set comprising: an endoscopic camera comprising an optical endoscope and a camera coupled to the optical endoscope, the camera comprising the image sensor and the video processing circuit, and a videoendoscopic probe comprising an inspection tube and a control handle fixed to the proximal end of the inspection tube, the control handle housing the video processing circuit, the inspection tube housing the image sensor and a distal multicore cable linking the video processing circuit to the image sensor.

According to an embodiment, the video processing circuit is configured to perform functions of synchronization, signal processing, and power supply, which are strictly necessary to manage the image sensor and to supply a standardized video signal to the video link, the video processing circuit being linked to the image sensor through a distal multicore cable comprising a supply link transmitting at least one direct supply voltage to the image sensor, an image signal link transmitting an image signal supplied by the image sensor, and a synchronization link transmitting at least one synchronization clock signal of the image sensor.

According to an embodiment, the image sensor is associated to an interface circuit linked to the video processing circuit through a distal multicore cable and configured to amplify an electrical signal coming from the image sensor before transmitting it to the video processing circuit through the distal multicore cable.

According to an embodiment, the video processing circuit comprises a signal processing digital processor which supplies the standardized video signal and which is controlled by a program parameterized by commands received through the control link.

According to an embodiment, the video link of the proximal multicore cable comprises a first video link to transmit a luminance component of the standardized video signal and a second video link different from the first video link, to transmit a chrominance component of the standardized video signal, or a single video link transmitting a single composite video signal gathering the luminance and chrominance components of the standardized video signal.

According to an embodiment, the videoendoscopic equipment unit comprises a connector to be removably connected to the proximal multicore cable.

According to an embodiment, the proximal multicore cable comprises a connector to be connected to an operating equipment unit.

Embodiments also concern an operating equipment unit of a videoendoscopic system, comprising an operating circuit configured to: be linked through a proximal multicore cable to a videoendoscopic equipment unit, receive through a video link of the proximal multicore cable a standardized analog video signal directly usable by a video monitor, power a videoendoscopic equipment unit through a supply link of the proximal multicore cable, and transmit control signals of a videoendoscopic equipment unit through a control link of the proximal multicore cable.

According to an embodiment, the operating circuit is configured to transmit through the control link operation parameters of a video processing circuit of the videoendoscopic equipment unit to which the operating equipment unit is connected, according to an identification information of a type of videoendoscopic equipment unit.

According to an embodiment, the operating circuit is configured to receive through the control link, the identification information of a type of videoendoscopic equipment unit to which the proximal multicore cable is connected.

According to an embodiment, the operating circuit is configured to receive through the control link remote control commands coming from a videoendoscopic equipment unit to which the proximal multicore cable is connected.

According to an embodiment, the video link of the proximal multicore cable comprises a first video link to transmit a luminance component of the standardized video signal and a second video link different from the first video link, to transmit a chrominance component of the standardized video signal, or a single video link transmitting a single composite video signal gathering the luminance and chrominance components of the standardized video signal.

According to an embodiment, the operating circuit comprises a primary power supply circuit providing a direct supply voltage to the operating circuit and through the supply link, to a videoendoscopic equipment unit to which the proximal multicore cable is connected.

According to an embodiment, the operating circuit comprises a circuit for the video encrusting of alphanumeric characters into video images transmitted by the standardized video signal received.

According to an embodiment, the operating circuit comprises a control circuit connected to a control keyboard.

According to an embodiment, the operating equipment unit comprises a connector to be removably connected to the proximal multicore cable.

According to an embodiment, the operating circuit is configured to be connected to a computer and to: generate from a standardized analog video signal received through the video link, a digital video signal usable by a computer, transmit to the computer the digital video signal generated, and transmit control signals between the computer and the control link.

According to an embodiment, the operating equipment unit comprises a light generator to light the proximal end of a beam of lighting fibers of the videoendoscopic equipment unit.

According to an embodiment, the operating equipment unit is configured to transmit through the control link commands received from the computer and allowing features of the standardized analog video signal to be set.

According to an embodiment, the operating equipment unit is configured to be connected to the computer through at least one link of USB type and to transmit through the link of USB type the video signal usable by the computer, and the control signals.

According to an embodiment, the operating equipment unit is configured to compress the standardized analog video signal received through the proximal multicore cable, so as to generate the video signal usable by the computer.

Embodiments also concern a videoendoscopic system comprising a videoendoscopic equipment unit and an operating equipment unit linked through a proximal multicore cable to the videoendoscopic equipment unit, the videoendoscopic equipment unit comprising an image sensor and a video processing circuit linked to the image sensor, the video processing circuit being configured to: transmit synchronization signals and direct voltages, necessary for the operation of the video processing circuit and the image sensor, supply from electrical signals supplied by the image sensor, a standardized analog video signal directly usable by a video monitor on a low-impedance video link of a proximal multicore cable, receive a direct supply voltage through a supply link of the proximal multicore cable, and receive control signals through a control link of the proximal multicore cable.

According to an embodiment, the videoendoscopic equipment unit is configured to perform functions of synchronization, signal processing, and power supply, which are strictly necessary to manage an image sensor and to supply a standardized video signal to the operating equipment unit through the proximal multicore cable.

According to an embodiment, the videoendoscopic equipment unit and the operating equipment unit are configured to emit and receive through to the control link commands coming from the videoendoscopic equipment unit and commands coming from the operating equipment unit.

According to an embodiment, the videoendoscopic system comprises a computer connected to the operating equipment unit and configured to display on a screen images of the video signal supplied by the videoendoscopic equipment unit and transmitted adapted by the operating equipment unit.

According to an embodiment, the computer is programmed to memorize and implement a driver for managing a video link between the computer and the operating equipment unit, and to memorize and implement a driver for managing a bidirectional control link between the computer and the interface device.

According to an embodiment, the computer is configured to store elementary instruction pages, each page being specific to a type of videoendoscopic equipment unit and corresponding to the setting of operation parameters of the video processing circuit of the videoendoscopic equipment unit.

According to an embodiment, the computer is configured to transmit to the videoendoscopic equipment unit, through the operating equipment unit an elementary instruction page, after an action on a control element of the computer.

According to an embodiment, the computer is programmed to perform a function of encrusting alphanumeric characters into the images visualized, and/or a function of saving onto a memory support unitary images or sequences of images of the video signal.

According to an embodiment, the videoendoscopic equipment unit is of a type comprising a videoendoscopic probe comprising an inspection tube and a control handle fixed to the proximal end of the inspection tube, the control handle housing the video processing circuit linked to the operating equipment unit through the proximal multicore cable, or of a type comprising an optical endoscope and a camera coupled to the optical endoscope, the head of the camera comprising a video processing circuit linked to the operating equipment unit through the proximal multicore cable.

to Embodiments of the invention will be described hereinafter, in relation with, but not limited to the appended figures wherein:

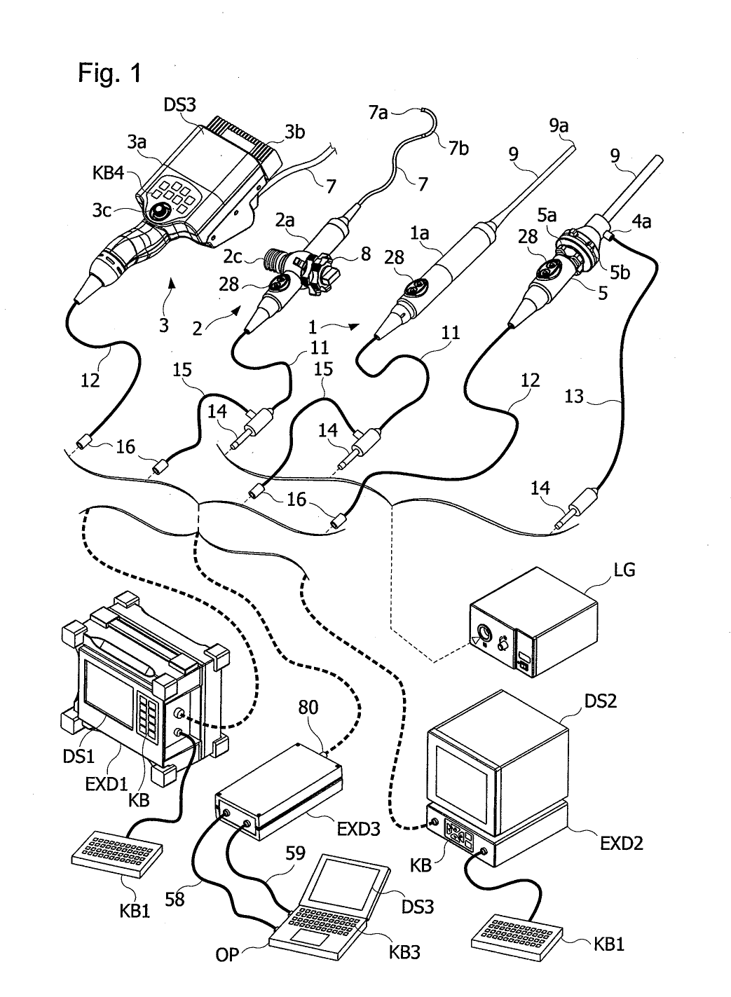

FIG. 1 shows different configurations of a videoendoscopy system, according to one embodiment,

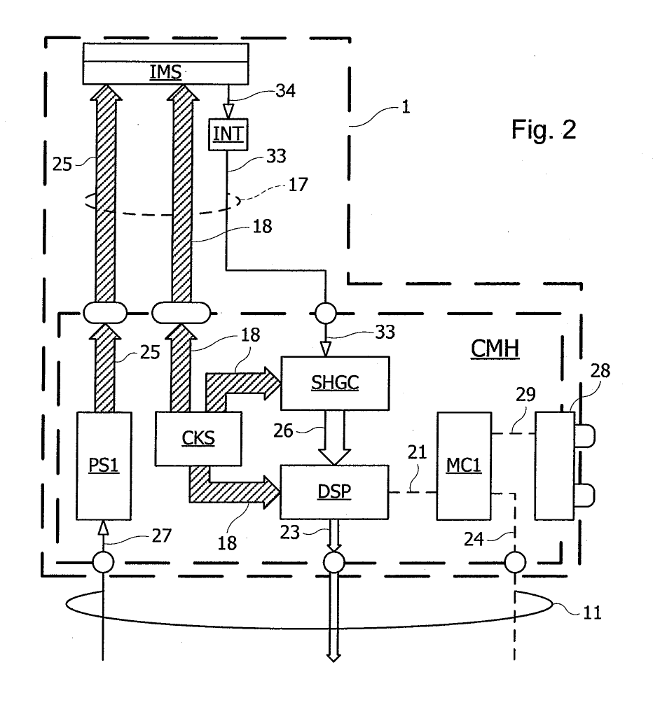

FIG. 2 schematically shows the general electrical architecture of a type of videoendoscopic probe of the videoendoscopic system of FIG. 1,

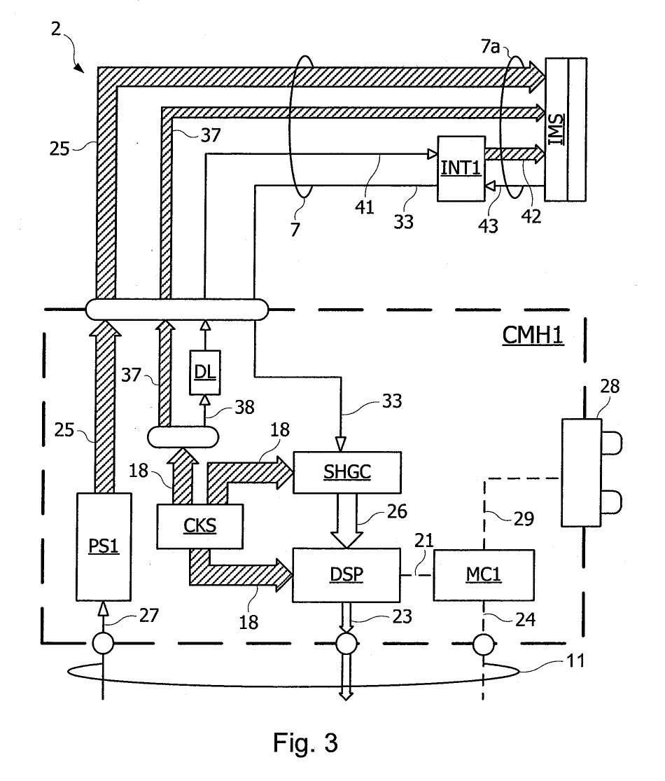

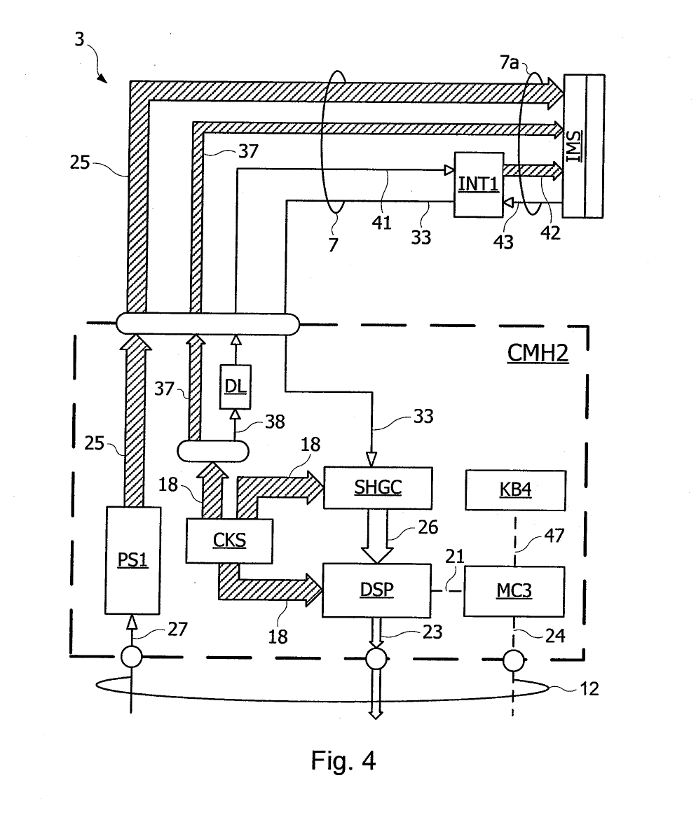

FIGS. 3 and 4 schematically show the general electrical architecture of another type of videoendoscopic probe of the videoendoscopic system of FIG. 1,

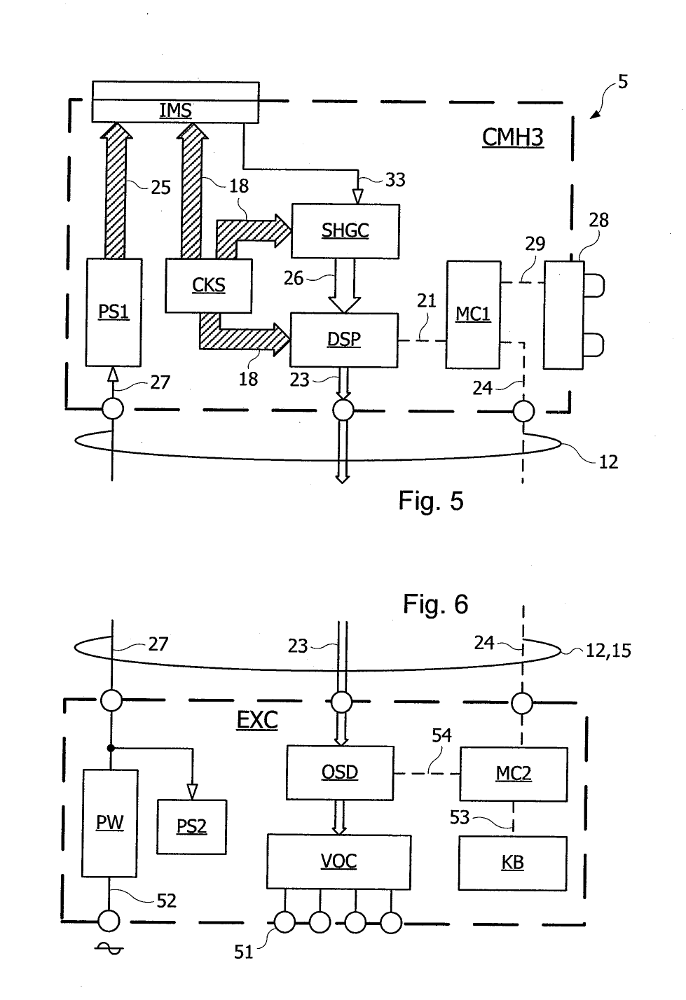

FIG. 5 schematically shows the general electrical architecture of an endoscopic camera of the videoendoscopic system of FIG. 1,

FIGS. 6 to 8 schematically show the general electrical architecture of a type of operating equipment unit of the videoendoscopic system of FIG. 1,

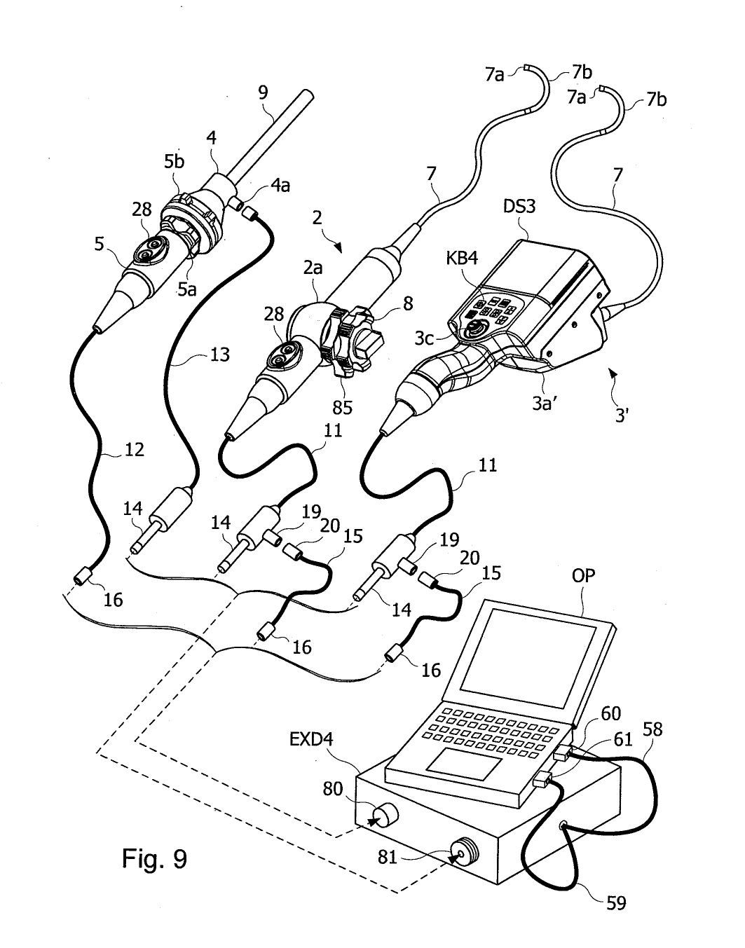

FIG. 9 shows different configurations of a videoendoscopy system, comprising an interface device according to one embodiment, connected to a computer.

FIG. 1 shows different configurations of videoendoscopic system, according to one embodiment. In FIG. 1, the system comprises a videoendoscopic equipment unit of various types 1, 2, 3, 4-5, which may be connected to an operating equipment unit, also of various types EXD1, EXD2, EXD3, as well as to a light generator LG. The videoendoscopic equipment unit performs the functions of synchronization, signal processing, and power supply, which are strictly necessary to manage the image sensor and to supply a standardized analog video signal to the operating equipment unit. The videoendoscopic equipment unit is controlled by the operating equipment unit through a serial link, for example of RS232 type, allowing in particular the features of the standardized analog video signal to be set.

The videoendoscopic equipment unit 1 is a videoendoscopic probe, which may be of the axial or deviated viewing type, comprising a rigid inspection tube 9, a distal tip 9a at the distal end of the inspection tube 9, a control handle 1a of small dimensions, which distal end is attached to the proximal end of the inspection tube 9, and an umbilical cable 11 fixed to the proximal end of the control handle. The distal tip 9a houses the distal end of a beam of lighting fibers, as well as an optoelectronic device comprising in particular an objective, and an image sensor. The inspection tube 9 houses the beam of lighting fibers and a distal multicore cable linking the image sensor to a circuit housed in the control handle 1a. The control handle 1a is equipped with remote control keys 28, and may also comprise an optical focusing control ring, and if need be, a control ring allowing the rotation of the optical viewing axis around the mechanical axis of the probe, if it is deviated viewing, to be controlled. The umbilical cable 11 houses the beam of lighting fibers which proximal end is housed into a lighting tip 14 which may be connected to the light generator LG, as well as a proximal multicore cable 15 which proximal end is equipped with a multipin connector 16.

The videoendoscopic probe 2 is of the type having a distal tip deflection deformable in two perpendicular planes and two directions in each plane. The probe 2 comprises a control handle 2a of small dimensions, an inspection tube 7 which may be flexible (in the example of FIG. 1) or rigid, which proximal end is attached to a distal part of the control handle, and an umbilical cable 11 fixed to a proximal part of the control handle 2a. The distal end of the inspection tube 7 houses a distal tip deflection 7b, a distal tip 7a housing an optoelectronic device comprising an objective, an image sensor and the distal end of a beam of lighting fibers. The inspection tube 7 houses the beam of lighting fibers, control cables of the distal tip deflection, and a multicore cable linking the optoelectronic device in the distal tip to an electronic circuit housed in the control handle 2a. The control handle 2a is operably identical to that of the probe 1 except that its control devices only comprise the remote control buttons 28 and wheels 8 laterally arranged on the handle, to control the orientation of the tip deflection in two perpendicular planes. The umbilical cable 11 houses the beam of lighting fibers which proximal end is housed in the lighting tip 14, and a multicore cable linking the electronic circuit housed in the handle 2a to the multipin connector 16.

The videoendoscopic probe 2 may integrate a lighting device 2c using a LED as a source of light. In this case, the probe comprises the umbilical cable 12 not housing any beam of lighting fibers.

The videoendoscopic probe 3 comprises a control handle 3a voluminous enough to support a control keyboard KB4, and to house a video processing electronic circuit, a powered tip defection control device controlled by a joystick 3c, and a lighting device 3b using a LED as a source of light. The handle 3a may also house a small visualization screen DS3 to view the images supplied by the electronic circuit. All the other elements of the probe 3 are identical to those of the videoendoscopic probe 2 previously described.

The videoendoscopic equipment unit 4-5 is of the type optical endoscope or laparoscope 4 (comprising a rigid optical inspection tube 9) associated to a camera 5. The endoscope 4 comprises a lighting base 4a housing a part of a beam of lighting fibers 13 which proximal end is housed in the lighting tip 14. The camera 5 comprises the two remote control keys 28, a proximal part fixed to an umbilical cable 12 which proximal end is equipped with the multipin connector 16. The distal part of the camera comprises an adaptation objective provided with a focusing ring 5a and a quick fixing mount 5b allowing the objective to be mechanically locked to a proximal auxiliary lens of the optical endoscope 4.

The three probes 1, 2, 3 and the camera 5 may be connected by the multipin connector 16 equally to one of the operating equipment units EXD1, EXD2, EXD3. The equipment unit EXD1 comprises a visualization screen DS1 and a control keyboard KB or may be connected to an external control keyboard KB1. The equipment unit EXD2 comprises a control keyboard KB or may be connected to the external control keyboard KB1, or to a visualization screen DS2. The equipment unit EXD3 is an interface device allowing one of the probes 1, 2, 3 or the camera 5 to be connected to a computer OP for example of the type personal computer which may be portable. The equipment unit EXD3 comprises a connection base 80 configured to receive the connector 16. The term “computer” hereinafter refers to a standard equipment unit comprising a central unit, a random access memory and possibly one or more mass storage units (hard disk), a keyboard KB3, a visualization screen DS3, and input/output ports. The interface device EXD3 allows the computer OP to be connected to one of the probes 1, 2, 3, or the camera 5, so that the keyboard KB3 may be used to control the probe or the camera, and the screen DS3 may display in particular the images supplied by the probe or the camera.

Thanks to the architecture shown in FIG. 1, one of the other operating equipment unit EXD1, EXD2, EXD3 may be more profitable. It may therefore be more complex and expensive, by being equipped for example with a high-definition video output, and/or a network connection, and/or a digital device for saving images or image sequences. The use of a single operating equipment unit for several types of videoendoscopic equipment units 1, 2, 3, 4-5 allows the user to avoid knowing several modes of use of operating equipment units. Thus, the user only has to know a single control keyboard and a single set of setting procedures for all the videoendoscopic equipment units susceptible of being connected to the operating equipment unit. In addition, the user may choose by program the functions allocated to the two remote control keys 28.

In addition, the possibility to connect several videoendoscopic equipment units different from or identical to a same operating equipment unit also brings a great flexibility of use in a same surgical block, by allowing a sterile equipment unit to be connected while the equipment unit previously used is being sterilized.

FIG. 2 shows the electrical architecture of the videoendoscopic probe 1. In FIG. 2, the videoendoscopic probe 1 comprises a distal image sensor IMS and an electronic video processing circuit CMH linked to the image sensor IMS. The circuit CMH is housed in the control handle 1a and is linked to the image sensor through a distal multicore cable 17 housed in the inspection tube 9. A videoendoscopic probe for medical use such as a laparoscopic probe comprises a rigid inspection tube 9 of low length (lower than 30 cm) housing the multicore cable 17. Such a length does not cause significant phase shifts of the fast clock signals which are transmitted by the circuit CMH to the image sensor IMS through the multicore cable 17. The result is that such probes do not require circuit for correcting the phase shift of fast clock signals.

The image sensor IMS is associated to an interface circuit INT which amplifies an image signal 34 generated by the image sensor IMS to supply an amplified image signal 33. The interface circuit INT may be made by a simple transistor or an operational amplifier. The link between the circuit CMH and the image sensor IMS, i.e. the distal multicore cable 17, comprises electrical links transmitting the following electrical signals:

one or more supply voltages 25 of the image sensor IMS and the circuit INT,

synchronization signals 18 (slow and fast clock signals) required for the operation of the image sensor IMS, and

the amplified image signal 33 supplied by the circuit INT.

According to one embodiment, the video processing circuit CMH gathers all the functions strictly required for the operation of the image sensor IMS. The circuit CMH thus comprises a signal processing device, a synchronization circuit CKS, a control device, and a power supply circuit PS1.

The signal processing device comprises a circuit SHGC performing the functions of sampling/blocking and gain automatic control, and a digital signal processing processor DSP. The function of sampling/blocking the circuit SHGC receives the image signal 33 and supplies a sampled image signal to the function of gain automatic control. The function of automatic gain control, for example realized with an operational amplifier, slaves the amplitude of the image samples to the instantaneous lighting of the sensor IMS, to supply a corrected sampled image signal 26. The processor DSP receives the corrected sampled signal 26, and supplies a standardized analog video signal 23, for example of Y/C type in PAL or NTSC standard. To that end, the processor DSP performs the following signal processing functions:

analog/digital conversion of the samples of the signal 26,

extraction of the R-Y and B-Y components of the digitized samples,

elaboration of the digital components of luminance Y and chrominance C, by dematrixing the components R-Y and B-Y,

correction of the luminance component Y, comprising in particular integrating the video signal with a closed-loop control of the integration clock at the average value of luminance (electronic shutter), digital filtering, correcting black level, gamma and outlines,

correction of the chrominance component C, comprising in particular correcting the white balance, digital filtering, and correcting gamma and outlines,

digital/analog conversion of the corrected digital components Y and C,

band-pass filtering, phasing and upgrading the analog components Y and C, to obtain a standardized analog video signal 16 of Y/C or composite type, in PAL or NTSC standard according to the image sensor.

The synchronization circuit CKS comprises a clock signal generator supplying synchronization signals 18 comprising several fast clock signals at the “pixel” frequency (around 17 MHz in PAL standard) and several slow clock signals at the “frame” frequency” (50 Hz in PAL standard or 60 Hz in NTSC standard). The synchronization signals are used to synchronize the sampling circuit SHGC, the processor DSP and the image sensor IMS. The clock signals 18 are directly transmitted to the sensor IMS.

The circuit control device CMH comprises a control processor MC1, for example of the microcontroller type, connected to a parametering interface of the digital processor DSP through a bidirectional serial logic link 21, for example of the TTL type. The control device also comprises remote control keys 28 linked through a wire link 29 to the processor MC1, and a bidirectional serial link 24, for example in RS 232 standard, to link the processor MC1 to an operating equipment unit EXD1, EXD2, EXD3.

The power supply circuit PS1 comprises several switched-mode power supplies providing direct voltages required to power the various circuits of the circuit CMH, and the direct supply voltages 25 of the sensor IMS and the circuit INT. The circuit PS1 is powered by a direct supply voltage 27. The umbilical cable 11 houses the beam of lighting fibers and a proximal multicore cable gathering electrical links necessary for the transmission of the supply voltage 27, the standardized analog video signal 23, and the serial link 24. The small number of electrical conductors of the proximal multicore cable housed in the umbilical cable 11 of the videoendoscopic equipment unit 1 results from the functional structure of videoendoscopic equipment units and the optimization of electrical signals at their interface. Thus, due to the integration into the videoendoscopic equipment units of a multiple power supply circuit PS1 generating the various direct voltages required for their operation and the operation of the image sensor IMS, the power supply of a videoendoscopic equipment unit only requires a simple direct voltage, for example 9 or 12 V, transmitted by two conductors. The proximal multicore cable 11 thus constitutes the only compatibility constraint between videoendoscopic equipment units and operating equipment units.

The video signal supplied by videoendoscopic equipment units is a low impedance standardized YC signal (>100 Ohm, for example 75 Ohm), in PAL or NTSC standard, which may be simply transmitted through two coaxial cable, one transmitting a luminance signal, and the other a chrominance signal. Such a signal respects better than a composite signal the useful information comprised in the electrical signal supplied by the image sensor, and requires for the transmission thereof, less conductors than a RGB signal or a digital video signal. It is also to be noted that a video signal of YC type in low impedance allows an excellent quality of image to be obtained.

In addition, the bidirectional serial link 24 only requires two conductors. A link of RS232 type is also little sensitive to disturbances. The proximal multicore cable housed in the umbilical cable 11, therefore only carries signals which are little sensitive to disturbances. The absence of fast clock signal in particular, makes it possible to provide videoendoscopic equipment units with umbilical cables of various lengths, and even to render the umbilical cable 11 removable from the videoendoscopic equipment unit and interchangeable by providing a connection base attached to the videoendoscopic equipment unit, on which a connector attached to the proximal end of the umbilical cable may be connected. It is to be noted that the interchangeability of the umbilical cable constitutes a central asset for the on-site maintenance of videoendoscopy systems.

A signal processing program, strictly specific to the model of the image sensor IMS implemented in the videoendoscopic probe, is loaded into the digital processor DSP. Any setting modifying the parametering of the processing program results from a command applied to the operating equipment unit connected to the link 24. Such a command may trigger via the link 24 and the processor MC1, the loading into the digital processor DSP of a page of elementary instructions which are previously stored in the operating equipment unit, and which are also specific to the type of videoendoscopic probe, and in particular to the model of image sensor implemented in the videoendoscopic probe. During the connection of the probe 1 to the operating equipment unit EXD1, EXD2, EXD3, the processor MC1 generates a specific identification code of the type of videoendoscopic probe, and therefore specific to the image sensor IMS implemented. This identification code is sent to the operating equipment unit via the serial link 24. During the use of the videoendoscopic system, the processor MC1 transmits to the digital processor DSP, via the serial link 21, elementary instruction pages for video setting received from the operating equipment unit through the serial link 24, these pages being selected by the operating equipment unit according to the probe identification code received. The identification code may be memorized by the processor MC1 or a specific circuit. The processor MC1 may be configured to set the operation parameters of the processor DSP relating in particular to colorimetry, outlines, brightness and white balance.

FIG. 3 shows the electrical architecture of the videoendoscopic probe 2. In FIG. 3, the videoendoscopic probe 2 differs from that shown in FIG. 2 in that it comprises the inspection tube 7 linking the image sensor IMS to an electronic video processing circuit CMH1, the tube generally being longer than the inspection tube 9 of the probe 1. The circuit CMH1 differs from the circuit CMH in that a fast clock signal 38 is extracted from the synchronization signals 36 to be transmitted to an interface circuit INT1 through a phase shifting circuit DL comprising a delay line. The interface circuit INT1 performs the following functions:

a function of amplifying the electrical signal 34 generated by the image sensor IMS, this function performed for example by a simple transistor or an operational amplifier, supplying an amplified electrical signal 33, and

a synchronization function which receives a delayed fast clock signal or “pixel” 41, from the circuit CMH1, and forms this signal and generates from this signal other fast clock signals necessary for the synchronization of the sensor IMS, all these fast clock signals 42 being directly transmitted to the image sensor IMS.

The circuit DL supplies a delayed fast clock signal 41 by subjecting a clock signal 38 of the clock signals 18 a calculated delay to compensate the sum of delays resulting from the transit duration of the fast clock signal 41 in the inspection tube 7, the transit duration of the electrical signal 33 generated by the interface circuit INT1, and the phase shifts introduced by the interface circuit INT1, in the transmission of fast clock signals 42 to the image sensor IMS, as well as in the transmission of the electrical signal 33 to the sampling circuit SHCG. The slow clock signals 37 of the clock signals 18 are directly transmitted to the sensor IMS.

The multicore cable 11 housed in the inspection tube 7 and linking the distal tip 7a to the circuit CMH1 in the control handle 2a gathers electrical links transmitting the following signals:
direct supply voltages 25 generated by the circuit CMH1 and directly transmitted to the image sensor IMS,
the electrical signal 33 generated by the interface circuit INT1,
the delayed “pixel” clock signal 41, and
the slow clock signals 37.

FIG. 4 shows the electrical architecture of the videoendoscopic probe 3. In FIG. 4, the videoendoscopic probe 4 differs from that shown in FIG. 3 in that it comprises an electronic video processing circuit CMH2 and in that the probe 3 is linked to an operating equipment unit EXD1, EXD2, EXD3 through an umbilical cable 12 not housing any beam of lighting fibers. The circuit CMH2 differs from the circuit CMH1 in that the remote control keys 28 are replaced by a control keyboard KB4, and the control processor MC1 is replaced by a control processor MC3, for example of the microcontroller type, more powerful than the processor MC1, linked through a parallel link 47 to the control keyboard KB4, and connected to the links 21 and 24. The processor MC3 may memorize elementary instruction pages each corresponding to a video parameter setting of the processor DSP. The instruction pages are supplied to the processor DSP either directly from an action on one of the keys of the keyboard KB4, or indirectly from an order transmitted through the link 24 and triggered by an action of the user on the keyboard KB, KB1, KB3 of an operating equipment unit EXD1, EXD2, EXD3. The processor MC3 may be configured to set the operation parameters of the processor DSP relating to colorimetry, outlines, brightness, and to enable functions of image freezing, zoom and image inversion of the image viewed on the screen DS3 or the visualization screen of the operating equipment unit to which the probe is connected.

FIG. 5 shows the electrical architecture of the camera 5. In FIG. 4, the videoendoscopic probe 4 differs from that shown in FIG. 2 in that the processing circuit CMH is replaced by a processing circuit CMH3 and in that the camera 5 is linked to an operating equipment unit EXD1, EXD2, EXD3 through an umbilical cable 12 not housing any beam of lighting fibers. The circuit CMH3 differs from the circuit CMH in that the links 25, 18 and 33 are directly connected to the image sensor IMS.

FIG. 6 shows the electrical architecture of an operating circuit EXC of the operating equipment unit EXD1 or EXD2. The operating circuit EXC gathers all the functions necessary to manage one of the videoendoscopic equipment units 1, 2, 3, 4-5. Thus, the circuit EXC comprises a video output module VOC, a character generator OSD, a microcontroller-based control processor MC2, a control keyboard KB, a global power supply circuit PW, and a power supply circuit PS2 for powering the circuit EXC. The character generator OSD receives the standardized analog video signal through the link 23 and inserts on demand alphanumeric characters into video images. The video output module VOC receives the analog video signal supplied by the character generator OSD and generates on video outputs 51 video signals complying with one or more video standards. Thus, the output module VOC may, depending on its complexity, generate a composite video signal, and/or a YC video signal, and/or a RGB video signal associated to a synchronization signal, and/or a HDI signal, and/or a compressed USB video signal, etc.

The processor MC2 is linked through the serial link 24 to the processor MC1 of the circuit CMH, CMH1, CMH3 or to the processor MC3 of the circuit CMH2. The processor MC2 is controlled by the keyboard KB to which it is linked through a matrix (or parallel) link 53. The processor MC2 may also be controlled by the remote control keys 28 or the keyboard KB4 to which it is linked through the serial link 24. The processor MC2 is connected to the character generator OSD through a parallel link 54.

The processor MC2 is configured to receive and acknowledge the identification signal generated by the processor MC1, MC3, and allocate a function to each of the remote control keys 28 or the keyboard KB4. The processor MC2 is also configured to control the circuit OSD. The processor MC2 permanently has a library of programs originally loaded and allowing control procedures strictly identical for all the models of probes or cameras which may be connected to the operating equipment unit EXD1, EXD2 to be applied. Each program of the library is specific to a model of probe or camera. The processor MC2 is configured to automatically select a specific program during the connection of the equipment unit EXD1, EXD2 to the videoendoscopic equipment unit (probe 1, 2, 3 or camera 5), thanks to the identification signal transmitted by the processor MC1, MC3. Each program gathers a series of elementary instruction pages, each page corresponding to a type of setting defining several operation parameters of the program for managing the videoendoscopic equipment unit stored in the digital processor DSP. The execution of a command by the processor MC2 is triggered by an action on the keys of the control keyboard KB. The command triggered may depend on instructions displayed in a menu incrusted by the circuit OSD into the video signal viewed.

The main power supply circuit PW is powered by an alternating voltage 52, and generates the direct voltage 27 used to power on the one hand the power supply circuit PS1 of the circuit CMH, CMH1, CMH2, CMH3, and on the other hand the power supply circuit PS2 supplying various voltages required for the operation of the circuit EXC.

The cable 12, 15 comprises electrical links transmitting the direct voltage 27 of the main power supply of the circuit CMH-CMH3, generated by the circuit EXC, the standardized analog video signal 23 generated by the digital processor DSP, and the bidirectional serial link 24 linking the processor MC1 to the circuit EXC.

The operating circuit EXC may comply with videoendoscopic equipment categories using the same technology implementing identical signal processing digital processors associated to identical image sensors. Thus, the operating circuit EXC may comply with identical probes or cameras equipped with image sensors of CCD ⅓ inch type with umbilical cables of various lengths. The operating equipment unit EXC may also comply with videoendoscopic equipment units using the same technology implementing identical signal processing digital processors associated to image sensors of different sizes and/or resolutions. The operating equipment unit EXC may for example comply with a camera equipped with an image sensor of the type CCD ⅓ inch/752×582 pixels, a probe equipped with an image sensor of the type CCD ⅙ inch/752×582 pixels, and a probe equipped with a sensor of the type CCD 1/10 inch/500×582 pixels. The operating equipment unit EXC may also comply with equipment units using different technologies, in particular equipped with cameras single CCD/Tri-CCD or equipped with image sensors using different technologies (CMOS/CCD).

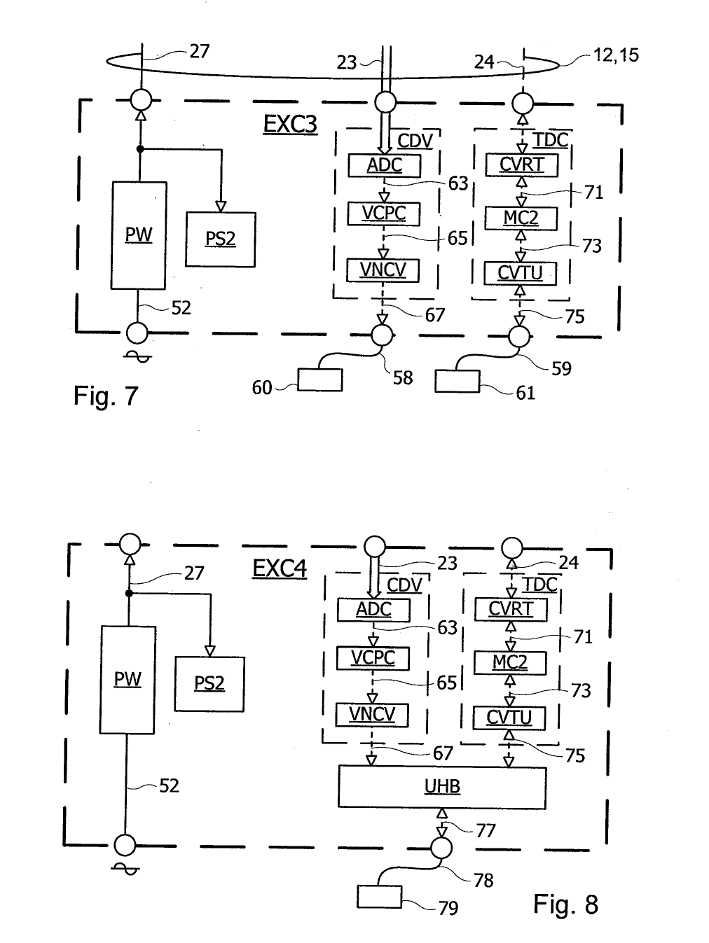

FIG. 7 shows the electrical architecture of an operating circuit EXC3 of the operating equipment unit EXD3 consisting of an interface device connected between a computer OP and a videoendoscopic equipment unit 1, 2, 3, 4-5. The operating circuit EXC3 comprises a power supply circuit, a video encoding circuit for the standardized video signal to be used by the computer and transmitted to a standard input of the computer, and an encoding circuit to convert the control signals passing through the order link into a format compatible with the computer. The operating circuit EXC3 also comprises a multipin electrical connection base intended to be connected to the multipin connector 16 integrated into the proximal end of the multicore cable 12, 15. To be connected to the computer OP, the circuit EXC3 comprises two cords 58, 59 equipped with standard connectors 60, 61, for example of USB type, to be connected to two ports of same type of the computer OP.

The circuit EXC3 comprises a main power supply circuit PW, a video encoding circuit CDV, and a bidirectional serial code conversion circuit TDC. The circuit PW is mains-operated or powered by a battery, or by the computer OP which may provide a supply voltage, for example, through the link 58 and/or the link 59. The circuit PW provides the supply voltage 27 which is transmitted on the one hand directly to a power supply circuit PS2 of the circuit EXC3, and on the other hand, via the multicore cable 12, 15, to the power supply circuit PS1 of the circuit CMH-CMH3.

The video encoding circuit CDV receives, via the multicore cable 12, 15 the analog video signal 23 supplied by the processor DSP and supplies a compressed digital video signal 67, for example in USB or USB2 standard, to be directly usable by a personal computer. The signal 67 is transmitted through the link 58 to a computer OP. The circuit CDV comprises an anolog-to-digital converter ADC, a video compressing circuit VCPC, and a digital video encoder VNCV. The converter ADC is configured to convert the analog video signal 23 into a digital video signal 63, for example digital serial signal to the TTL standard. The circuit VCPC receives the signal 63 and compresses this signal, for example in MPEG mode, to obtain a compressed digital video signal 65 in TTL standard. The encoder VNCV converts the signal 65 into the digital video signal 67.

The serial code conversion circuit TDC is configured to perform converting signals complying with the serial link 24, for example in the RS 232 standard, into signals usable by a personal computer, for example in the USB standard, and conversely. The circuit TDC is linked in input to the serial bidirectional link 56 housed in the umbilical cable 11, 12, and in output to a serial bidirectional link 75, 59, for example in USB2 standard. The circuit TDC allows the processor MC1, MC3 to communicate with the portable computer connected to the link 59. The circuit TDC comprises a bidirectional converter CVRT, the processor MC2, and a bidirectional converter CVTU. The converter CVRT is connected on one side to the link 24, and on the other side to a link 71 for example in TTL standard. The converter CVRT is configured to convert signals in RS232 standard into TTL standard, and conversely. The processor MC2 is connected to the link 71 and a link 73 also in TTL standard. The processor MC2 is configured to process data coming from the links 71 and 73, and to parameterize the converter CVTU to render it compatible with a connection port of a personal computer, for example a USB port. The converter CVTU is connected on one side to the link 73, and on the other side to a link 75, 59. The converter CVTU is configured to convert signals in TTL standard into a standard which may be processed by a personal computer, for example the USB standard, and to perform an inverse conversion.

The computer OP, for example of the type portable personal computer, is connected to the links 58, 59 of the circuit EXC3. The computer has a program performing the following functions:
displaying on the screen the images of the video signal supplied by the videoendoscopic equipment unit,
processing and viewing the video images transmitted by the link 67, 58,
incrusting alphanumeric characters into the images visualized,
saving in the memory of the computer or a removable memory support (USB key or memory card) connected to the computer, unitary images or sequences of images coming from the video link 67, or from an image processing program implemented by the computer,
sending commands allowing the features of the images of the video signal to be set, the commands being for example introduced or enabled by means of the computer keyboard,
storing and implementing a driver for managing the video link 67, 58 linked to the computer through the connector 60,
storing and implementing a driver for managing the bidirectional serial link 75, 59 connected to the computer through the connector 61,
storing elementary instruction pages, each page corresponding to the setting of an operation parameter of the processor DSP, each page being specific to a type of videoendoscopic equipment unit.

The computer OP may thus memorize as many sets of elementary instruction pages as types of videoendoscopic equipment units it is susceptible of managing. The transmission to the processor DSP and the execution by the latter of an instruction page selected according to the type of videoendoscopic equipment unit is triggered by an action on a control element (keyboard, mouse, etc.) set by program, from the computer. The instruction page selected is transmitted to the processor DSP through the link 59, the circuit TDC, the link 24, the processor MC1, MC3 and the link 21.

It is to be noted that the instruction pages of a videoendoscopic equipment unit may be stored by the processor MC1, MC3 of the videoendoscopic equipment unit. In this case, the computer is simply configured to select one of these pages to be executed by the processor DSP. To that end, a list of the instruction pages available may be transmitted by the processor MC1, MC3 to the computer OP through the circuit EXC3 during an initialization procedure of the videoendoscopic system.

FIG. 8 shows the electrical architecture of an operating circuit EXC4 of the operating device EXD3, according to another embodiment. In FIG. 8, the operating circuit EXC4 differs from the operating circuit EXC3 in that it further comprises a multiplexing circuit or signal concentrator UHB connected on one side to the links 67 and 75 and on the other side to a single link 77. The link 77 is linked to a cable 78 equipped with a connector 79 provided to be connected to the computer OP. The circuit UHB may thus be of the “HUB” type or USB concentrator. The provision of the circuit UHB allows the connection of the circuit EXC4 to the computer OP to be limited to a single cable, and therefore a single connection port of the computer to be used.

FIG. 9 shows a videoendoscopic system according to one embodiment. In FIG. 9, the videoendoscopic system differs from that shown in FIG. 1 in that the operating equipment unit EXD3 is replaced by an operating equipment unit EXD4 and the videoendoscopic equipment unit 3 is replaced by an endoscopic equipment unit 3′. The videoendoscopic equipment unit 3′ differs from the endoscopic equipment unit 3 in that it does not comprise any light generator. The control handle 3a′ of the videoendoscopic equipment unit 3′ is connected to an umbilical cable 11 housing a beam of lighting fibers.

The operating equipment unit EXD4 differs from the equipment unit EXD3 in that it further comprises a light generator connected to a connection base 81 configured to receive the lighting tip 14. In addition, the lighting tip 14 comprises a connection base 19 linked through a multicore cable to the electronic circuit CMH-CMH3 housed in the handle 1, 2, 3′, 5. The connection base 19 is provided to receive a connector 20 at the end of the multicore cable 15 which proximal end is equipped with the multipin connector 16.

It will appear clearly to those skilled in the art that the present invention is susceptible of various embodiments and applications. In particular, the invention is not limited to a signal processing processor supplying a standardized video signal of Y/C type. The only important thing is that this video signal may be transmitted through a small number of low impedance links (<100 Ohms), which excludes digital video signals. Thus, for example the standardized video signal supplied by the processor DSP may also be of video composite type, transmitted trough a single coaxial cable, and in which the luminance signal is coded by the chrominance signal. The standardized video signal supplied by the signal processing processor may also be of the Y/Cb/Cr type. Such a signal is transmitted through three coaxial cables respectively transmitting the signals Y, Y-B and Y-R. This solution reveals to be more adapted to video sensors of the “tri-CCD” type generating signals corresponding to the three chromatic components. It may also be considered to transmit the standardized video signal in differential digital form LVDS (Low-voltage differential signaling). However, the video link allowing such a signal to be transmitted in parallel form requires a great number of conductors (32 conductors for a 2×8 bit video signal).

The invention is not limited either to the implementation of the TTL, RS232 and USB standards within the video processing circuit CMH, CMH1, CMH2, CMH3 and the operating circuit EXC, EXC1, EXC3, EXC4, between these circuits, and between the operating circuit EXC3, EXC4 and the computer OP. Other standards adapted to the types of signals to be transmitted and the interfaces of the processor DSP and the processors MC1, MC2, MC3 may admittedly be implemented.

The invention is not limited either to an operating circuit EXC comprising a video output module VOC with several video outputs. In fact, as the video signal 23 coming from the processor DSP is directly usable on a video monitor, this signal may directly be transmitted to the connection interface of the operating circuit EXC, to an external video equipment unit (video monitor, video recording device, computer OP, . . . ).

In addition, it is not required to provide the control circuit CMH-CMH3 with an identification circuit of the videoendoscopic equipment unit. In fact, the identification information of the videoendoscopic equipment unit may be supplied by the user through a keyboard KB, KB1, KB3, KB4, after the connection of the videoendoscopic equipment unit to the operating equipment unit. It is not required either to provide the videoendoscopic equipment unit with remote control buttons 28. This arrangement is only provided for ergonomic reasons, the commands corresponding to the buttons 28 may be introduced by means of the keyboard KB.

The invention is not limited either to an interface circuit (EXC3, EXC4) comprising a primary power supply circuit PW. It may in fact be considered that the supply voltage provided to the interface circuit EXC3 EXC4 is directly usable by the power supply circuits PS1 and PS2 to power the interface device and the videoendoscopic equipment unit 1, 2, 3, 4-5.

1. Videoendoscopic equipment unit comprising an image sensor and a video processing circuit linked to the image sensor and configured to supply a video signal from electrical signals provided by the image sensor,
the video processing circuit being configured to:
generate and transmit synchronization signals and direct voltages, necessary for the operation of the video processing circuit and the image sensor,
supply a standardized analog video signal directly usable by a video monitor on a low-impedance video link of a proximal multicore cable,
receive a direct supply voltage through a supply link of the proximal multicore cable, and
receive control signals through a control link of the proximal multicore cable.

2. Videoendoscopic equipment unit according to claim 1, wherein the video processing circuit comprises an identification circuit configured to transmit through the control link an identification information of a type of the videoendoscopic equipment unit.

3. Videoendoscopic equipment unit according to claim 1, wherein the video processing circuit comprises a remote control circuit linked to a control link of the proximal multicore cable for remotely controlling through the control link an operating equipment unit connected to the proximal multicore cable.

4. Videoendoscopic equipment unit according to claim 1, having a type belonging to a set comprising:
an endoscopic camera comprising an optical endoscope and a camera coupled to the optical endoscope, the camera comprising the image sensor and the video processing circuit,
a videoendoscopic probe comprising an inspection tube and a control handle fixed to the proximal end of the inspection tube, the control handle housing the video processing circuit, the inspection tube housing the image sensor and a distal multicore cable linking the video processing circuit to the image sensor.

5. Videoendoscopic equipment unit according to claim 1, wherein the video processing circuit is configured to perform functions of synchronization, signal processing, and power supply, which are strictly necessary to manage the image sensor and to supply a standardized video signal to the video link, the video processing circuit being linked to the image sensor through a distal multicore cable comprising a supply link transmitting at least one direct supply voltage to the image sensor, an image signal link transmitting an image signal supplied by the image sensor, and a synchronization link transmitting at least one synchronization clock signal of the image sensor.

6. Videoendoscopic equipment unit according to claim 1, wherein the image sensor is associated to an interface circuit linked to the video processing circuit through a distal multicore cable and configured to amplify an electrical signal coming from the image sensor before transmitting it to the video processing circuit through the distal multicore cable.

7. Videoendoscopic equipment unit according to claim 1, wherein the video processing circuit comprises a signal processing digital processor which supplies the standardized video signal and which is controlled by a program parameterized by commands received through the control link.

8. Videoendoscopic equipment unit according to claim 1, wherein the video link of the proximal multicore cable comprises a first video link to transmit a luminance component of the standardized video signal and a second video link different from the first video link, to transmit a chrominance component of the standardized video signal, or a single video link transmitting a single composite video signal gathering the luminance and chrominance components of the standardized video signal.

9. Videoendoscopic equipment unit according to claim 1, comprising a connector to be removably connected to the proximal multicore cable.

10. Videoendoscopic equipment unit according to claim 1, wherein the proximal multicore cable comprises a connector to be connected to an operating equipment unit.

11. Operating equipment unit of a videoendoscopic system, comprising an operating circuit configured to:
be linked through a proximal multicore cable to a videoendoscopic equipment unit,
receive through a video link of the proximal multicore cable a standardized analog video signal directly usable by a video monitor,
power a videoendoscopic equipment unit through a supply link of the proximal multicore cable, and
transmit control signals of a videoendoscopic equipment unit through a control link of the proximal multicore cable.

12. Operating equipment unit according to claim 11, wherein the operating circuit is configured to transmit through the control link operation parameters of a video processing circuit of the videoendoscopic equipment unit to which the operating equipment unit is connected, according to an identification information of a type of videoendoscopic equipment unit.

13. Operating equipment unit according to claim 12, wherein the operating circuit is configured to receive through the control link, the identification information of a type of videoendoscopic equipment unit to which the proximal multicore cable is connected.

14. Operating equipment unit according to claim 11, wherein the operating circuit is configured to receive through the control link remote control commands coming from a videoendoscopic equipment unit to which the proximal multicore cable is connected.

15. Operating equipment unit according to claim 11, wherein the video link of the proximal multicore cable comprises a first video link to transmit a luminance component of the standardized video signal and a second video link different from the first video link, to transmit a chrominance component of the standardized video signal, or a single video link transmitting a single composite video signal gathering the luminance and chrominance components of the standardized video signal.

16. Operating equipment unit according to claim 11, wherein the operating circuit comprises a primary power supply circuit providing a direct supply voltage to the operating circuit and through the supply link, to a videoendoscopic equipment unit to which the proximal multicore cable is connected.

17. Operating equipment unit according to claim 11, wherein the operating circuit comprises a circuit for the video encrusting of alphanumeric characters into video images transmitted by the standardized video signal received.

18. Operating equipment unit according to claim 11, wherein the operating circuit comprises a control circuit connected to a control keyboard.

19. Operating equipment unit according to claim 11, comprising a connector to be removably connected to the proximal multicore cable.

20. Operating equipment unit according to claim 11, wherein the operating circuit is configured to be connected to a computer and to:
generate from a standardized analog video signal received through the video link, a digital video signal usable by a computer,
transmit to the computer the digital video signal generated, and
transmit control signals between the computer and the control link.

21. Operating equipment unit according to claim 11, comprising a light generator to light the proximal end of a beam of lighting fibers of the videoendoscopic equipment unit.

22. Operating equipment unit according to claim 20, configured to transmit through the control link commands received from the computer and allowing features of the standardized analog video signal to be set.

23. Operating equipment unit according to claim 20, configured to be connected to the computer through at least one link of USB type and to transmit through the link of USB type the video signal usable by the computer, and the control signals.

24. Operating equipment unit according to claim 20, configured to compress the standardized analog video signal received through the proximal multicore cable, so as to generate the video signal usable by the computer.

25. Videoendoscopic system comprising a videoendoscopic equipment unit and an operating equipment unit linked through a proximal multicore cable to the videoendoscopic equipment unit, the videoendoscopic equipment unit comprising an image sensor and a video processing circuit linked to the image sensor,
the video processing circuit being configured to:
transmit synchronization signals and direct voltages, necessary for the operation of the video processing circuit and the image sensor,
supply from electrical signals supplied by the image sensor, a standardized analog video signal directly usable by a video monitor on a low-impedance video link of a proximal multicore cable,
receive a direct supply voltage through a supply link of the proximal multicore cable, and
receive control signals through a control link of the proximal multicore cable.

26. Videoendoscopic system according to claim 25, wherein the videoendoscopic equipment unit is configured to perform functions of synchronization, signal processing, and power supply, which are strictly necessary to manage an image sensor and to supply a standardized video signal to the operating equipment unit through the proximal multicore cable.

27. Videoendoscopic system according to claim 26, wherein the videoendoscopic equipment unit and the operating equipment unit are configured to emit and receive through the control link commands coming from the videoendoscopic equipment unit and commands coming from the operating equipment unit.

28. Videoendoscopic system according to claim 25, comprising a computer connected to the operating equipment unit and configured to display on a screen images of the video signal supplied by the videoendoscopic equipment unit and transmitted adapted by the operating equipment unit.

29. Videoendoscopic system according to claim 28, wherein the computer is programmed to memorize and implement a driver for managing a video link between the computer and the operating equipment unit, and to memorize and implement a driver for managing a bidirectional control link between the computer and the interface device.

30. Videoendoscopic system according to claim 28, wherein the computer is configured to store elementary instruction pages, each page being specific to a type of videoendoscopic equipment unit and corresponding to the setting of operation parameters of the video processing circuit of the videoendoscopic equipment unit.

31. Videoendoscopic system according to claim 30, wherein the computer is configured to transmit to the videoendoscopic equipment unit, through the operating equipment unit an elementary instruction page, after an action on a control element of the computer.

32. Videoendoscopic system according to claim 28, wherein the computer is programmed to perform a function of encrusting alphanumeric characters into the images visualized, and/or a function of saving onto a memory support unitary images or sequences of images of the video signal.

33. Videoendoscopic system according to claim 28, wherein the videoendoscopic equipment unit is of a type comprising a videoendoscopic probe comprising an inspection tube and a control handle fixed to the proximal end of the inspection tube, the control handle housing the video processing circuit linked to the operating equipment unit through the proximal multicore cable, or of a type comprising an optical endoscope and a camera coupled to the optical endoscope, the head of the camera comprising a video processing circuit linked to the operating equipment unit through the proximal multicore cable.
